(19) United States
(12) Patent Application Publication
(10) Pub. No.: US 2001/0049895 A1
(43) Pub. Date: Dec. 13, 2001

(54) Promotional hanger

(76) Inventor: Doyle G. Burke, Woodinville, WA (US)

Correspondence Address: DEAN A. CRAINE, P.S., 400 - 112TH AVE. NE, STE. 140, BELLEVUE, WA, 98004, US

(21) Appl. No.: 09/755,546

(22) Filed: Jan. 5, 2001

Related U.S. Application Data
(60) Provisional application No. 60/175,126, filed on Jan. 6, 2000.

(51) Int. Cl. G09F 3/04; G09F 3/10

(52) U.S. Cl. 40/630

(57) ABSTRACT

An inexpensive promotional hangar used to attach a neck or wrist strap to a desired item. The promotional hanger includes an elongated body made of a material divided into three sections. The first section extends from one end to approximately the mid-line axis of the body. A second section is formed adjacent to the first section that, during assembly, is folded upward to form an extending narrow tab. Located adjacent to the second section and opposite the first section is a third section. First and second fold lines are aligned transversely on the body, separating the first and second sections, and the second and third sections, respectively, and enabling the second section 30 to bend upward. A third fold line is transversely aligned over the second section, thereby enabling it to be folded in half to form a tab structure. An adhesive is spread over the entire back surface of the body, enabling the second section to be folded together to form the tab, and enabling the first and third sections to be attached to an item. Holes are manufactured in the second section to which a strap may be attached. A removable, protective sheet is then placed over the outer surface of the adhesive.

This utility patent application in based on the provisional patent application (Serial No. 60/175,126) on Jan. 6, 2000.

### BACKGROUND OF THE INVENTION

1. Field of the Invention

This invention pertains to promotional items and, more particularly, to such items that can be attached to another object and utilized as a hanger.

2. Description of the Related Art

Most businesses are interested in novel promotional items that can be used to sell their products and services. Ideally, these items should be relatively inexpensive to manufacture and to distribute so that they may be given away at no charge, or at a low price. Promotional items that also have some functional aspect that address a common problem for their customers are of particular interest to many businesses.

The camera manufacturers, film manufacturers, and film developers are examples of businesses highly interested in novel promotional items. The markets for the products and services offered by these businesses are all price-driven, therefore the prices for competing products and services are nearly identical. A novel, inexpensive, promotional item that addresses a problem for customers of these products would be of great interest.

Disposable cameras are usually sold without clips designed to attach to a neck or wrist strap worn by the user. As a result, disposable cameras are usually transported in the user's pocket or purse. For vacationers and small children, an empty pocket or purse may not be available for a camera, forcing the user to hold the camera in his or her hand. Given these choices, many users would rather not use a disposable camera altogether.

What is needed is an inexpensive, promotional device that can attach to a disposable camera or a similar object, and can be used with a strap for easy transport.

### SUMMARY OF THE INVENTION

It is an object of the present invention to provide an inexpensive promotional item.

It is another object of the present invention to provide such an item that can be attached to a disposable camera.

It is a further object of the present invention to provide such an item that can be used as a hanger that may be attached to a neck or wrist strap of a user for easier transport.

These and other objects are met by an inexpensive, promotional item designed to attach to a disposable camera or similar item. The promotional item includes an elongated body made of a material divided into three sections. The first section extends from one end to approximately the mid-line axis of the elongated body. A second section is formed adjacent to the first section. Located adjacent to the second section, and opposite the first section, is a third section. First and second fold lines are aligned transversely on the body, which separate the first and second sections and the second and third sections, respectively. A third fold line is transversely aligned over the mid-line axis of the second section, thereby enabling it to be folded in half.

An adhesive is spread over the entire back surface of the body. A protective sheet is then placed over the outer surface of the adhesive. During use, the protective sheet is removed so that the second section may be folded over to form an upward extending, double-layered tab. The first and third sections may be attached to the sides of the camera. Manufactured on each half of the second section is a hole. The holes are longitudinally aligned directly opposite each other so that when the second section is folded upward along the centerfold line, the holes are registered. A neck or wrist strap may then be attached to the holes. Advertisements or other promotional indications may be printed on the front surface of the body.

### BRIEF DESCRIPTION OF THE DRAWINGS

FIG. 1 is a perspective view of the promotional hanger, attached to a disposable camera.

FIG. 2 is a perspective view of the promotional hanger.

FIG. 3 is a top plan view of the promotional hanger.

FIG. 4 is a side elevational view of the promotional hanger, showing the protective sheet being removed.

### DESCRIPTION OF THE PREFERRED EMBODIMENT(S)

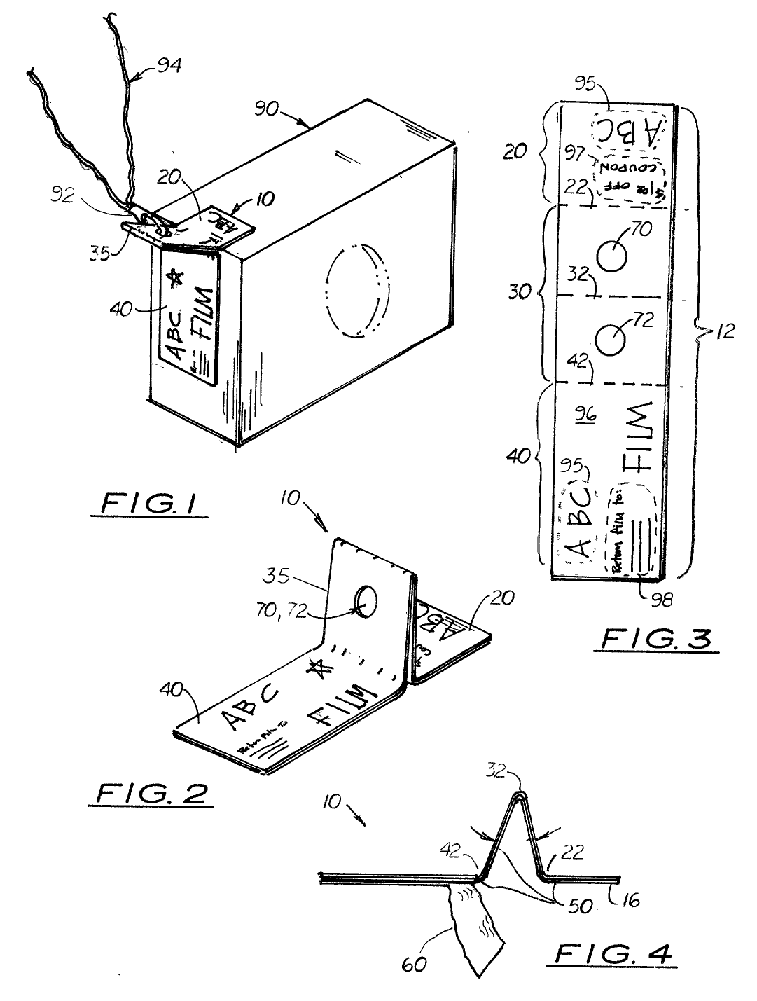

There is showing in FIGS. 1-4, a promotional hanger 10 designed to attach to the sides of an item, such as a disposable camera 90, typically carried by a neck or wrist strap 94. The promotional hanger 10 is designed to be easily attached to the item, and is made of paper or similar material that can have promotional indications, a trademark 95, color trade dress 96, coupon, mail-in information 97, and user information 98 printed thereon.

The promotional hanger 10 includes an elongated rectangular-shaped body 12 divided into three sections, 20, 30, 40, respectively. The first section 20 extends from one end to approximately one quarter of the length of the body 12. The second section 30 is formed adjacent to the first section 20, and extends to approximately the mid-line axis of the body 12. During assembly, the second section 30 is folded upward to form an extending narrow tab 35. Located adjacent to the second section 30 and opposite the first section 20 is the third section 40. First and second fold lines 22, 42, respectively, are formed transversely on the body 12, which separate the first and second sections 20, 30 and the second and third sections 30, 40, respectively, enabling the second section 30 to bend upward. A third fold line 32 is transversely aligned over the mid-line axis of the second section 30, thereby enabling it to be folded over as shown in FIG. 4.

A suitable adhesive 50 is spread over the entire back surface 16 of the body 12. A protective sheet 60 is then placed over the outer surface of the adhesive 50. During use, the protective sheet 60 is removed so that the second section 30 may be folded over to form an upward extending, double-layered tab 35, and the first and third sections 20, 40, respectively, may be attached to the adjacent sides of an item, such as the camera 90. Manufactured on each half of the second section 30 is a hole 70, 72. The holes 70, 72 are longitudinally aligned directly opposite each other so that when the second section 30 is folded upward around the third fold line 32, the holes 70, 72 are registered. Clips 92 attached to a neck or wrist strap 94 may then be attached to the holes 70, 72. Promotional material may be printed on the front surface of the body 12.

In compliance with the statute, the invention described herein has been described in language more or less specific as to structural features. It should be understood, however, that the invention is not limited to the specific features shown, since the means and construction shown comprise only the preferred embodiments for putting the invention into effect. The invention is therefore claimed in any of its forms or modifications within the legitimate and valid scope of the amended claims, appropriately interpreted in accordance with the doctrine of equivalents.

I claim:

1. A promotional hanger comprising:
a. an elongated body having a front surface and a back surface, said body is divided into a first, second and third section by two fold lines aligned transversely on said body;
b. a pair of holes formed on said second section, said holes being aligned so that when said second section is folded, said holes are registered;
c. an adhesive layer formed over said back surface of said body enabling said section to be folded into a double layer tab and first and third section to be selectively attached to a surface; and,
d. a removable film attached to said adhesive layer.

2. The promotional hanger, as recited in claim 1, further including advertising indicia printed on at least one said first, second or third section.

3. The promotional hangar, as recited in claim 1, further including a strap selectively attached to said holes on said body.
